(19) United States
(12) Patent Application Publication
(10) Pub. No.: US 2013/0094548 A1
(43) Pub. Date: Apr. 18, 2013

(54) METHOD FOR TRANSMITTING CHANNEL INFORMATION, DEVICE THEREOF, BASE STATION, AND METHOD FOR TRANSMITTING FOR BASE STATION THEREOF

(71) Applicant: Kyoungmin Park, Seoul (KR)

(72) Inventor: Kyoungmin Park, Seoul (KR)

(73) Assignee: Pantech Co., Ltd., Seoul (KR)

(21) Appl. No.: 13/806,533

(22) PCT Filed: Jun. 21, 2011
(86) PCT No.: PCT/KR2011/004516

§ 371 Date: Dec. 21, 2012

(30) Foreign Application Priority Data
Jun. 21, 2010 (KR) 10-2010-0058807

(51) Int. Cl. H04B 7/04; H04W 88/08

(52) U.S. Cl. CPC H04B 7/0417; H04B 7/0482; H04W 88/08
USPC 375/219; 375/296; 375/267

(57) ABSTRACT

The present disclosure relates to transmission and reception using a multiple-input multiple-output (MIMO) antenna in a wireless communication system in which a method includes: receiving a reference signal to estimate a channel; estimating a suitable pre-coding matrix from the estimated channel similar to a Discrete Fourier Transform (DFT) matrix which has at least two different DFT code books; providing a relatively large DFT matrix subset with a pre-coding matrix phase different from the set of said suitable pre-coding matrix; generating channel information which includes multiple access information on at least one DFT matrix which is small enough to be similar to said subset pre-coding matrix; and transmitting said channel information generated in said channel information generating step.

### CROSS-REFERENCE TO RELATED APPLICATIONS

This application is the National Stage Entry of International Application No. PCT/KR2011/004516, filed on Jun. 21, 2011 and claims priority from and the benefit of Korean Patent Application No. 10-2010-0058807, filed on Jun. 21, 2010, both of which are hereby incorporated by reference for all purposes as if fully set forth herein.

### BACKGROUND

1. Field

The present invention relates to a wireless communication system, and particularly, to a wireless communication system where both a transmitter side and a receiver side use a Multiple-Input Multiple-Output (MIMO) antenna.

2. Discussion

According to development of communication systems, consumers such as enterprises and individuals have used greatly various wireless terminals.

A current mobile communication system such as 3GPP, Long Term Evolution (LTE), LTE Advanced (LTE-A) or the like corresponds to a high speed and high capacity communication system capable of transmitting and receiving various data such as an image, radio data and the like, beyond providing a voice-based service, and accordingly, it is required to develop a technology that transmits high capacity data, which is comparable with a wired communication network and also to improve system performance by minimizing information loss and increasing a system transmission efficiency.

Meanwhile, a communication system has been used in which both a transmitter side and receiver side use a Multiple-Input Multiple-Output (MIMO) antenna. The MIMO communication system has a structure where a single terminal or a plurality of terminals receive or transmit a signal from or to one base station or the like.

### SUMMARY

In accordance with an aspect of the present invention, a transmission method of channel information by an apparatus in a wireless communication system is provided. The method includes estimating a channel by receiving a reference signal; estimating a precoding matrix suitable for the estimated channel from a DFT codebook including two or more sets having different similarities of Discrete Fourier Transform (DFT) matrixes, configuring a subset by DFT matrixes having a relatively large phase difference from the precoding matrix in a set including the precoding matrix, and generating channel information containing multiple access information on one or more DFT matrixes having a sufficiently low similarity with the precoding matrix within the subset; and transmitting the channel information generated in generating the channel information into an air.

In accordance with another aspect of the present invention, a channel information feedback apparatus in a wireless communication system is provided. The channel information feedback apparatus includes a channel estimator for estimating a channel receiving by a reference signal; a channel information generator for estimating a precoding matrix suitable for the channel estimated by the channel estimator from a DFT codebook including two or more sets having different similarities of Discrete Fourier Transform (DFT) matrixes, configuring a subset by DFT matrixes having a relatively large phase difference from the precoding matrix in a set including the precoding matrix, and generating channel information containing multiple access information on one or more DFT matrixes having a sufficiently low similarity with the precoding matrix within the subset; and a feedback unit for feeding back the generated channel information.

In accordance with another aspect of the present invention, a base station is provided. The base station includes a layer mapper for mapping a data symbol into a layer; a precoder for receiving feedback of channel state information and multiple access information from one or more user equipments and precoding mapped symbols by using each precoding matrix; a scheduler for, when the user equipment allows simultaneous accesses of the user equipment and one or more other user equipments, selecting a user equipment to receive data by using the channel state information and the multiple access information and generating precoding matrixes of the precoder; and an antenna array including two or more antennas for propagating a precoded symbol into an air, wherein, when a precoding matrix suitable for a channel estimated by receiving a reference signal by a user equipment is estimated in a DFT codebook including two or more sets having different similarities of DFT matrixes and a subset is configured by DFT matrixes having a relatively large phase difference from the precoding matrix in a set including the precoding matrix, the multiple access information is information on one or more DFT matrixes having a sufficiently low similarity with the precoding matrix within the subset.

In accordance with another aspect of the present invention, a transmission method of a base station is provided. The transmission method includes mapping a data symbol into a layer; receiving feedback of channel state information and multiple access information from one or more user equipments and precoding mapped symbols by using each precoding matrix; when the user equipment allows simultaneous accesses of the user equipment and one or more other user equipments, selecting a user equipment to receive data by using the channel state information and the multiple access information and generating precoding matrixes of a precoder; and propagating a precoded symbol into an air through an antenna array including two or more antennas, wherein, when a precoding matrix suitable for a channel estimated by receiving a reference signal by a user equipment is estimated in a DFT codebook including two or more sets having different similarities of DFT matrixes and a subset is configured by DFT matrixes having a relatively large phase difference from the precoding matrix in a set including the precoding matrix, the multiple access information is information on one or more DFT matrixes having a sufficiently low similarity with the precoding matrix within the subset.

### BRIEF DESCRIPTION OF THE DRAWINGS

FIG. 1 is a diagram schematically illustrating a wireless communication system to which embodiments are applied.

FIG. 2 illustrates that a base station transmits a reference signal to user equipments in a wireless communication system.

FIG. 3 illustrates that user equipments transmit channel state information and multiple access information to a base station in a wireless communication system according to an embodiment.

FIG. 4 is a configuration diagram illustrating each of the base station and the user equipments in FIGS. 2 and 3.

FIG. 5 is a block diagram illustrating a channel information feedback apparatus for each function according to an embodiment in a MIMO system.

FIG. 6 is a block diagram illustrating a channel information generator of FIG. 5.

FIG. 7 illustrates a pattern of a precoding gain of PMI=0 according to a resolution of a DFT precoding matrix and a propagation angle of the transmitter side.

FIG. 8 is a flowchart illustrating a channel state information feedback method according to another embodiment in a MIMO system.

FIG. 9 is a flowchart illustrating an example of a channel state information generation method according to another embodiment.

FIG. 10 is a block diagram illustrating a base station according to another embodiment.

FIG. 11 is a flowchart illustrating a transmission method of a base station according to another embodiment.

### DETAILED DESCRIPTION OF THE ILLUSTRATED EMBODIMENTS

Hereinafter, exemplary embodiments of the present invention will be described in detail with reference to the accompanying drawings. The same elements will be designated by the same reference numerals although they are shown in different drawings. Further, in the following description of the present invention, a detailed description of known functions and configurations incorporated herein will be omitted when it may make the subject matter of the present invention rather unclear.

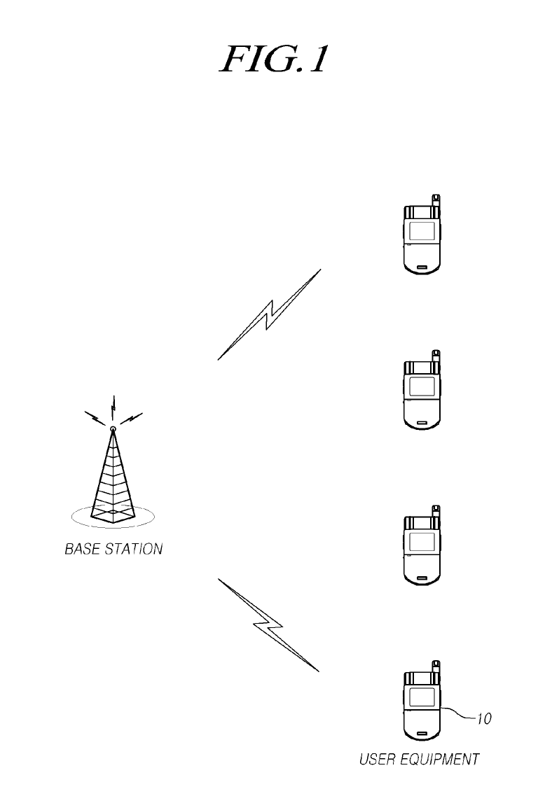

FIG. 1 is illustrates a wireless communication system to which embodiments are applied.

The wireless communication system may be widely installed so as to provide various communication services, such as a voice service, packet data and the like.

Referring to FIG. 1, the wireless communication system includes a User Equipment (UE) 10 and a Base Station (BS) 20.

Throughout the specification, the user equipment 10 may be an inclusive concept indicating a user terminal utilized in wireless communication, and should be construed as a concept including all of a User Equipment (UE) in WCDMA, LTE, HSPA and the like, and a Mobile Station (MS), a User Terminal (UT), a Subscriber Station (SS), a wireless device and the like in GSM.

The user equipment 10 can perform feedback of multiple access information described below and provides an apparatus thereof.

In general, the base station 20 or a cell may refer to a fixed station communicating with the terminal 10, and may also be referred to as another term such as a Node-B, an evolved Node-B (eNB), a Base Transceiver System (BTS), an access point, a relay node or the like.

The base station 20 can receive the feedback of the multiple access information from the user equipment 10 and transmit data or a signal by using the multiple access information.

In the specification, the user equipment 10 and the base station 20 are used as two inclusive transceiving subjects to embody the technology and technical idea described in the specification, and may not be limited to a predetermined term or word.

An embodiment of the present invention may be applicable to asynchronous wireless communication that is advanced to Long Term Evolution (LTE) and LTE-advanced through GSM, WCDMA, and HSPA, and may be applicable to synchronous wireless communication that is advanced to CDMA, CDMA-2000, and UMB. The present invention may not be construed as being limited to a specific wireless communication field, and should be construed as including all technical fields to which a technical idea of the present invention is applicable.

The wireless communication system to which embodiments of the present invention are applied may support uplink and/or downlink HARQ, and may use a Channel Quality Indicator (CQI) for link adaptation. Further, a multiple access scheme for a DL and a multiple access scheme for a UL may be different from each other, for example, the DL may use an Orthogonal Frequency Division Multiple Access (OFDMA) scheme, and the UL may use a Single Carrier-Frequency Division Multiple Access (SC-FDMA) scheme.

The wireless communication system considers using a Multiple User Multiple Input Multiple Output (MU-MIMO) scheme for simultaneously transmitting information to a plurality of users through the same band by using multiple antennas in order to support transmitting information to many users at a high speed. When two or more user equipments have a high channel propagation gain for the same band, the MU-MIMO scheme allows the two or more users to share the band so that more users can use a wider band, and also use a band having a better channel propagation gain, thereby improving an overall spectral efficiency.

Meanwhile, in order to implement an effective MIMO system, a channel information based precoder may be used. For the precoder, a method is required in which the user equipment 10 detects a channel state and informs the base station 20 of the detected channel state.

The method in which the user equipment 10 informs of channel information may be largely divided into a mode (explicit feedback mode) in which the user equipment 10 directly informs the base station 20 of the channel information and a mode (implicit feedback mode) in which the user equipment 10 determines a precoder scheme based on the channel information and informs the base station 20 of the precoder scheme. The latter has an advantage in that a closed loop precoding is possible with smaller overheads in comparison with the former (explicit feedback mode), but may not smoothly control interference between users in the MU-MIMO implementation because it cannot inform the base station of direct information on the channel.

In order to smoothly control the interference between the users by using the closed loop precoding scheme in the MU-MIMO implementation, a method of implicitly performing feedback of information on the use of the precoder based on the channel information and implicitly performing feedback of information for supporting the multiple accesses at the same time may be used.

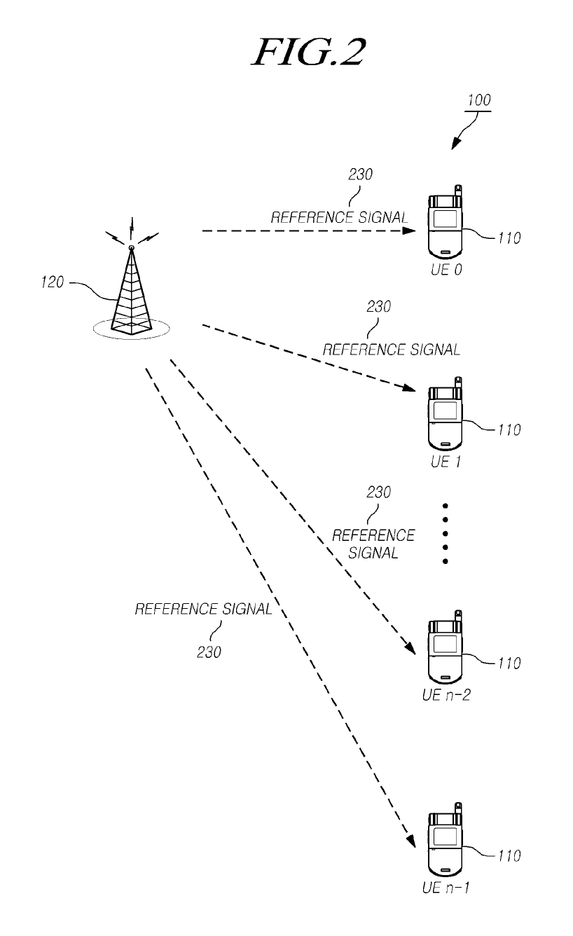

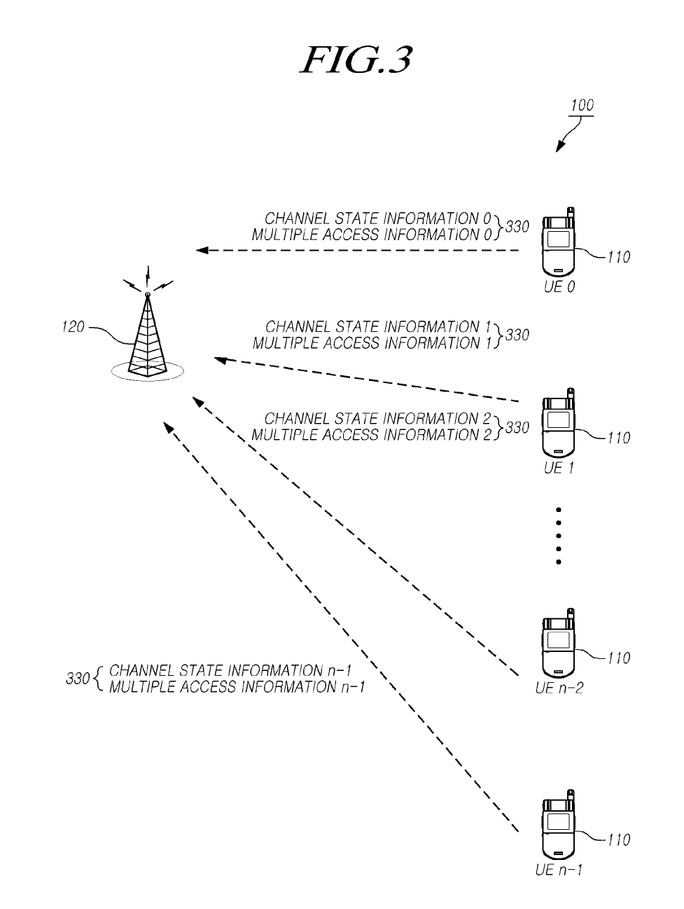

In the above description, the wireless communication system to which embodiments are applied has been discussed, and hereinafter, a process in which the base station and the user equipment exchange channel information in the wireless communication system will be discussed with reference to FIGS. 2 and 3.

FIG. 2 illustrates that the base station transmits a reference signal to user equipments in the wireless communication system. FIG. 3 illustrates that the user equipments transmit channel state information and multiple access information to the base station in the wireless communication system according to an embodiment.

Referring to FIGS. 2 and 3, a wireless communication system 100 may include a base station 120 and at least one user equipment existing within the wireless communication system 100, for example, n user equipments 110 (UE0 to UEn−1), like the wireless communication of FIG. 1. The user equipments 110 may be user equipments, which currently access or attempt an additional access.

Referring to FIG. 2, for data transmission and reception between the user equipments 110 and the base station 120, the base station 120 of a transmitter side may transmit a reference signal 230, and the user equipment 110 of a receiver side may estimate a frequency domain channel by using the reference signal 230. For example, the user equipment 110 may estimate a downlink channel in downlink transmission. Particularly, the user equipment 110 may perform an estimate of the complex channel of each carrier in OFDM transmission. On the contrary, the base station 120 may perform an estimate of an uplink channel in uplink transmission.

For the estimation of the frequency domain channel, a specific signal or symbol may be inserted into a frequency-domain grid at regular or irregular intervals. At this time, the specific signal or symbol may be variously named a reference signal, a reference symbol, a pilot symbol and the like, and the specific signal or symbol is referred to as the reference signal in the specification but the present invention is not limited thereto. Of course, the reference signal 230 may be used for a position estimate, transmission and reception of control information, transmission and reception of scheduling information, transmission and reception of feedback information and the like required for a wireless communication process between the user equipment and the base station as well as the estimation of the frequency domain channel.

In each of the downlink or uplink transmission, there are various types of reference signals, and new reference signals have been defined and discussed for various purposes. For example, in uplink transmission, there are a Demodulation RS (DM-RS), a Sounding RS (SRS) and the like as the reference signal. In downlink transmission, there are a Cell-specific RS (CRS), an MBSFN RS, a UE-specific RS and the like as the reference signal. Further, in the downlink transmission, there is a Channel State Information-Reference Signal (CSI-RS) as the reference signal transmitted from the base station to allow the user equipment 20 to obtain Channel State Information (CSI). The CSI-RS is used for reporting Channel Quality Indicator (CQI)/Precoding Matrix Indicator (PMI)/Rank Indicator (RI) and the like.

Referring to FIG. 3, each user equipment 110 receives the reference signal 230 and estimates a channel. Thereafter, each user equipment 110 transmits feedback of channel information 330 to the base station 120. At this time, the channel information contains channel state information on the user equipment itself (hereinafter, referred to as “channel state information), multiple access information on another user equipment according to multiple accesses decided by the user equipment, or interference information (hereinafter, referred to as “multiple access information) according to the multiple accesses. At this time, the channel state information may contain information on a precoding of the user equipment (referred to as a “precoding” or a “PC”) suitable for the estimated channel, for example, an index for the precoding matrix or a Precoding Matrix Indicator (PMI).

For example, in the MIMO allowing simultaneous accesses of n user equipments, each of the n user equipments 110 may transmit feedback of the channel state information, that is, the PMI to the base station 120.

Also, each user equipment 110 may measure a channel capacity or a channel quality by using the reference signal and report measured values (CQI) to the base station 120 as channel information.

Further, the multiple access information may be information on a precoding of another user equipment which is expected to give a smallest amount of interference to each user equipment when the base station 120 transmits a signal according to the channel state information, of which the feedback is received from the user equipment 120, or reversely, information on a precoding of another user equipment which is expected to give a largest amount of interference to each user equipment.

For example, in the MIMO allowing simultaneous accesses of n user equipments, each of the n user equipments 110 may transmit feedback of the multiple access information on other user equipments to the base station 120. Meanwhile, the base station 120 may receive the feedback of n multiple access information pieces reported from the n user equipments.

The base station 120 determines SU-MIMO transmission or MU-MIMO transmission based on channel information 330 containing channel state information, multiple access information, and channel qualities reported from each user equipment 110 and selects the user equipments. When the SU-MIMO transmission is determined, the base station 120 selects one user equipment. Meanwhile, when the MU-MIMO transmission is determined, the base station 120 compares the channel information 330 containing the CQIs, the channel state information, and the multiple access information reported from each user equipment 110 to select the user equipments.

The base station 120 configures a downlink channel with the selected user equipment 110 and communicates with the selected user equipment 110 through the downlink channel.

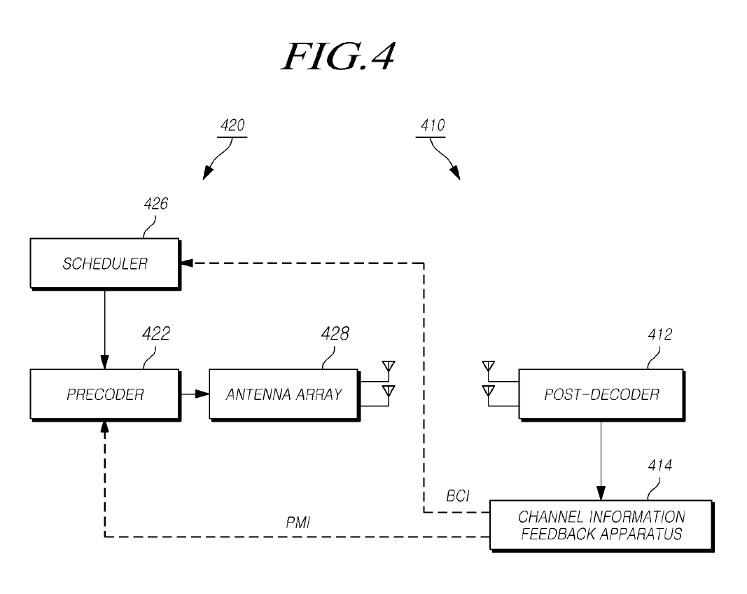

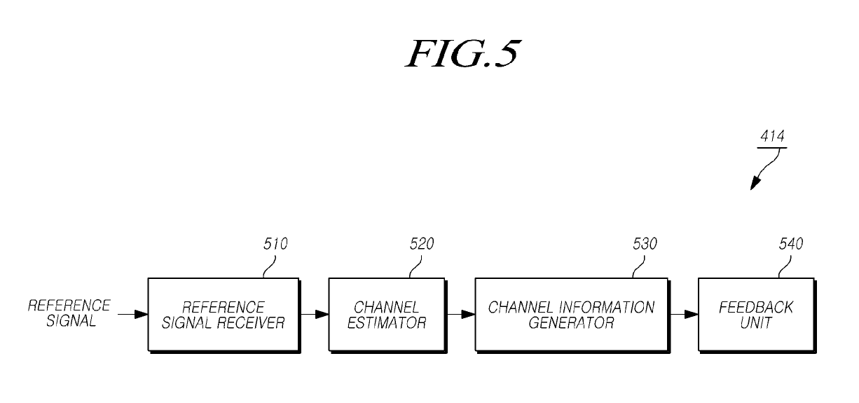

In the above description, the process in which the base station and the user equipment exchange the channel information in the wireless communication system has been discussed, and hereinafter, configurations of the base station and each of the user equipments will be described with reference to FIG. 4, and a channel information feedback apparatus according to an embodiment in a MIMO system will be described with reference to FIG. 5.

FIG. 4 is a configuration diagram illustrating each of the base station and the user equipments of FIGS. 2 and 3.

Referring to FIG. 4, each of user equipments 410 includes a post-decoder 412 and a channel information feedback apparatus 414. A base station 420 includes a precoder 422 for precoding data symbols by using a precoding matrix, an antenna array 428 for transmitting a precoded signal into the air, and a scheduler 426 for controlling the precoder 422 and the antenna array 428.

The post-decoder 412 processes a received signal and decodes the signal into an original data symbol by using the precoding matrix. The post-decoder 412 corresponds to the precoder 422 of the base station 420. The post-decoder 412 transmits a received reference signal to the channel information feedback apparatus 414.

The channel information feedback apparatus 414 may receive the reference signal and estimate a channel by using the reference signal. The channel information feedback apparatus 414 may generate the channel information containing the channel state information and the multiple access information. Meanwhile, the channel information feedback apparatus 414 may transmit feedback of the channel information to the base station 420.

For example, the channel information feedback apparatus 414 may select an index (PMI) of the precoding matrix of the user equipment suitable for the estimated channel from a codebook stored by the user equipment and transmits feedback of the PMI to the base station 420, specifically to the precoder 422.

As described below in detail, the channel state information may be the PMI of the precoding matrix suitable for the estimated channel selected from DFT matrixes of a DFT codebook consisting of Discrete Fourier Transform (DFT) matrixes including only indexes and a phase corresponding to each of the indexes.

Further, the channel information feedback apparatus 414 may transmit feedback of one of information on a precoding of another user equipment which is expected to give a smallest amount of interference to the user equipment when the base station 420 transmits a signal according to the precoding matrix reported by the user equipment, for example an index (Best Companion Indication: BCI) of the precoding matrix of another user equipment, or reversely, information on a precoding of another user equipment which is expected to give a largest amount of interference, for example, an index (Worst Companion Indication: WCI) of the precoding matrix of another user equipment to the base station 420, as the multiple access information.

As described below in detail, the multiple access information may be a best or optimal companion selection index (Best Companion Indicator/Index: BCI) for at least one DFT matrix having a sufficiently low similarity with the precoding matrix, within a subset corresponding to DFT matrixes having a relatively large phase difference from the precoding matrix in a set including the precoding matrix corresponding to at least one of the DFT matrixes of the DFT codebook suitable for the estimated channel from the DFT codebook including at least two sets having different similarities of the DFT matrixes.

For example, in the MIMO allowing simultaneous accesses of n user equipments, each of the n user equipments 410 may transmit feedback of the channel state information to the base station 420. Each of the n user equipments 410 may transmit feedback of multiple access information on other user equipments, for example, the BCI to the base station 420.

Further, the channel information feedback apparatus 414 may measure a channel capacity or a channel quality by using the reference signal and report measured values to the base station 420 as another channel information. When the multiple accesses to the base station 420 are performed by the user equipment and another user equipment by using the channel state information and the multiple access information reported by the user equipment, the channel information feedback apparatus 414 may calculate the channel capability and the channel quality and report calculated values to the base station 420 as channel information.

Referring back to FIG. 4, the base station 420 includes the precoder 422 for precoding data symbols by using the precoding matrix, the antenna array 428 for transmitting the precoded signal into the air, and the scheduler 426 for controlling the precoder 422 and antenna array 428.

The precoder 422 may precode data symbols by using the precoding matrix corresponding to the channel state information, of which the feedback is received from the user equipment 410.

The antenna array 428 may use a plurality of antennas.

The scheduler 426 of the base station 420 determines SU-MIMO transmission or MU-MIMO transmission based on the channel information containing the CQIs, the channel state information, and the multiple access information reported from the channel state feedback apparatus 414 and selects the user equipments. Meanwhile, when the SU-MIMO is determined, the scheduler 426 selects one user equipment. When the MU-MIMO is determined, the scheduler 426 compares the channel information containing the CQI, the channel state information, and the multiple access information reported from each user equipment 410 to select the user equipments.

The scheduler 426 may generate precoding matrixes of the selected one user equipment or two or more user equipments. As a result, the precoder 422 may precode the data symbol by using each of the precoding matrixes received from the scheduler 426.

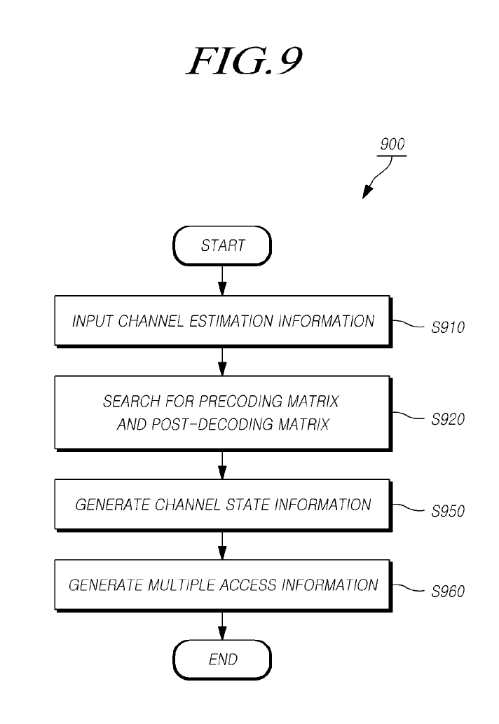

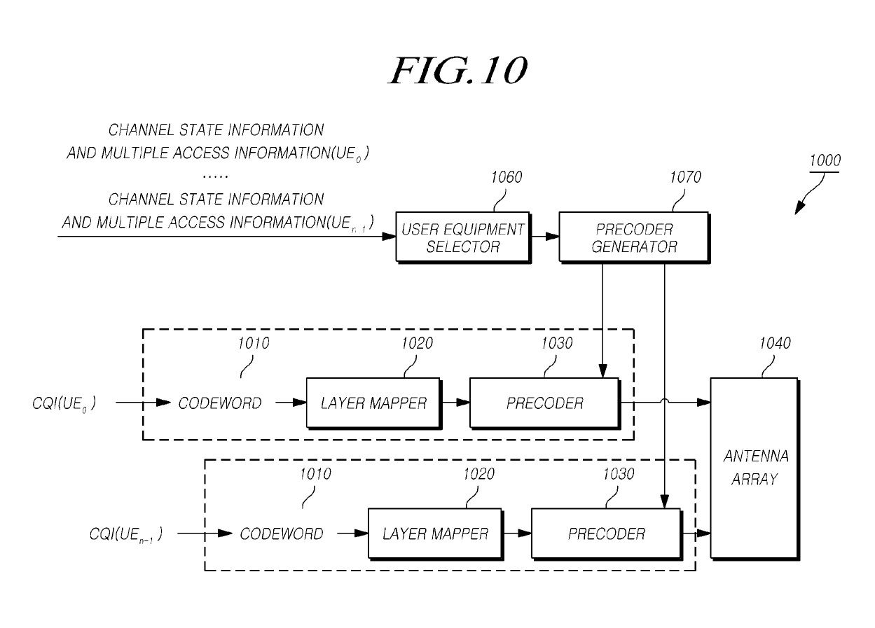

A detailed process in which the scheduler 426 selects SU/MU-MIMO transmission modes and user equipments will be described in more detail in comparison with a description of a base station or a base station apparatus with reference to FIGS. 9 and 10 below.

FIG. 5 is a block diagram illustrating the channel information feedback apparatus for each function according to another embodiment in the MIMO system.

Referring to FIG. 5, the channel information feedback apparatus 414 may be implemented by hardware or software within a pre-accessed UE which currently accesses, or an additional accessed UE which attempts an additional access, but the channel information feedback apparatus is not limited thereto and may be implemented in the base station and the like.

The channel information feedback apparatus 414 according to an embodiment largely includes a reference signal receiver 510 for receiving the reference signal, for example, a Channel State Information-Reference Signal (CSI-RS), Common Reference Signal (CRS), or Demodulation-Reference Signal (DM-RS) from the base station, a channel estimator 520 for estimating a channel by using the received reference signal, a channel information generator 530 for generating corresponding channel information based on a channel estimation result of the channel estimator 520, and a feedback unit 540 for feeding back the generated channel information.

The reference signal receiver 510 and the channel estimator 520 may be separately or integratively implemented in the above description, and may be integratively implemented in some cases.

Hereinafter, although the CSI-RS is described as an example of the reference signal, the present invention is not limited thereto and may use any reference signal.

The reference signal receiver 510 receives a cell-specific CSI-RS, and since the reference signal receiver 510 has information on the band (subcarrier) of the received signal and information on the symbol by which the CSI-RS is received, the reference signal receiver 510 may measure a CSI-RS reception value by determining a signal of the time-frequency domain.

The CSI-RS is the reference signal transmitted by the base station in order to enable the user equipment to estimate a downlink channel.

The channel estimator 520 can perform a function of estimating the channel by using the received CSI-RS. The channel estimate of the channel estimator 520 is performed as follows.

The reception value of the CSI-RS received by the reference signal receiver 510 is as defined in Equation 1 below, and r̅^{RS} is the reception value of the received CSI-RS, H is a propagation channel, t̅^{RS} is a transmission value of the transmitted CSI-RS, and η̅ is Gaussian noise in Equation 1.

r̅^{RS}=H t̅^{RS}+ η̅ [Equation 1]

Since r̅^{RS} corresponding to the reception value of the received CSI-RS may be known by the above measurement and t̅^{RS} corresponding to the transmission value of the CSI-RS is a value already known between the base station and the user equipment, H corresponding to the propagation channel may be estimated using a general channel estimation scheme. The propagation channel H corresponding to a channel estimation result of the channel estimator 520 may be a channel matrix or a covariance matrix.

Further, the channel estimator 520 may estimate a long term/wideband statistic property of the propagation channel H corresponding to the channel estimation result at regular intervals. For example, the long term/wideband statistic property may be an average value of the channel matrix for a predetermined time or a channel correlation matrix R expressed by Equation 2 below.

$$R = E [ {\sum }_{m = 1}^{N} {h}_{m} {h}_{m}^{H} ] \qquad [ Equation 2 ]$$

In Equation 2, E is an average of products of a Hermitian matrix formed by multiplying a channel matrix and a channel matrix having a conjugate transpose, and N is the number of channel matrixes considering the long term/wideband statistic property for a predetermined time.

Subsequently, the channel information generator 530 may generate channel state information based on the propagation channel H corresponding to the channel estimation result of the channel estimator 520 or the long term/wideband statistic property, for example, the channel correlation matrix R. For example, the channel information generator 530 may select an index of the precoding matrix (PMI) of the user equipment suitable for the propagation channel H estimated for a specific frequency band or the long term/wideband statistic property, for example, the channel correlation matrix R from the DFT codebook consisting of DFT matrixes including only indexes stored by the user equipment and a phase corresponding to each of the indexes, as the channel state information.

The channel information generator 530 may select information on a precoding of another user equipment which is expected to give a smallest amount of interference to the user equipment when the base station 420 transmits a signal according to the precoding matrix reported by the user equipment, for example, an index (BCI) of the precoding matrix of another user equipment or reversely, information on a precoding of another user equipment which is expected to give a largest amount of interference, for example, an index (WCI) of the precoding matrix of another user equipment from the codebook, as the multiple access information.

The multiple access information may be the BCI of at least one DFT matrix having a sufficiently low similarity with the precoding matrix, within a subset corresponding to DFT matrixes having a relatively large phase difference from the precoding matrix in a set including the precoding matrix corresponding to at least one of the DFT matrixes of the DFT codebook suitable for the estimated channel from the DFT codebook including at least two sets having different similarities of the DFT matrixes.

In the above description, components included in the channel information feedback apparatus according to an embodiment in the MIMO system have been discussed, and hereinafter, operations of generating the channel state information and the multiple access information by the channel information generator corresponding to one of the components of the channel information feedback apparatus according to an embodiment in the MIMO system will be described in detail.

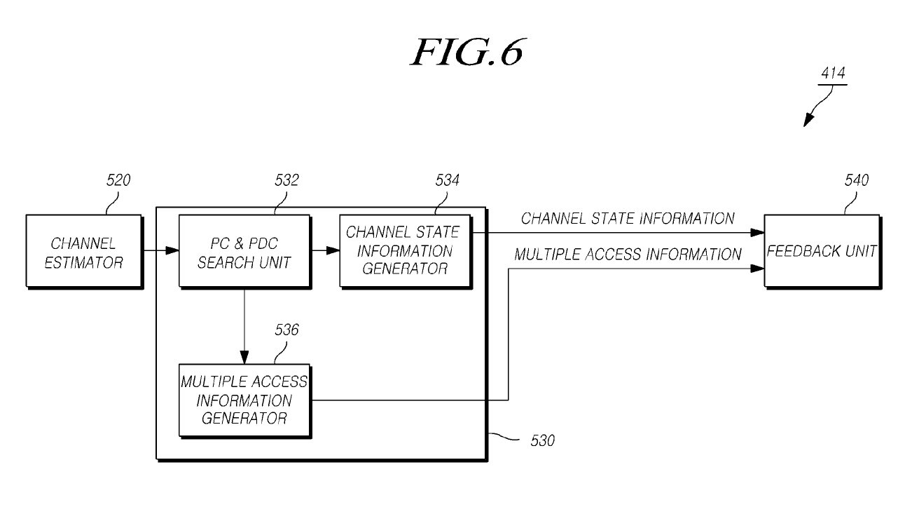

FIG. 6 is a block diagram illustrating the channel information generator of FIG. 5.

A channel information generator 530 includes a PC-PDC search unit 532 for searching for an optimal precoder and post-decoder based on an estimation result of a channel estimator 520, a channel state information generator 534 for generating channel state information based on optimal precoder and post-decoder information determined by the PC-PDC search unit 532, and a multiple access information generator 536 for generating multiple access information.

The PC-PDC search unit 532 may search for the optimal precoder and post-decoder based on the estimation result of the channel estimator 520 and determine an optimal precoding scheme or precoder (PC) and an optimal post-decoding scheme or post-decoder (PDC) by using various precoding techniques.

The PC-PDC search unit 532 may search for the optimal precoder information (precoding matrix) based on the propagation channel or the long term/wideband statistic property estimated by the cannel estimator 520 and estimate the post-decoder based on the found precoder information.

The PC-PDC search unit 532 may determine the optimal precoder and post-decoder through a search in the DFT codebook consisting of the DFT matrixes including only the indexes and the phase corresponding to each of the indexes. The PC-PDC search unit 532 selects the precoding matrix suitable for the estimated channel from the DFT matrixes of the DFT codebook consisting of the DFT matrixes including only the indexes and the phase corresponding to each of the indexes. At this time, since the DFT matrixes of the DFT codebook perform the precoding by considering a propagation angle and an incident angle of the signal, excellent performance can be proved.

Specifically, when a transmitted signal is Sₜ=P₀s₀+ . . . +Pₙsₙ, a received signal of a particular user equipment i is rᵢ=HᵢSₜ=HᵢP₀s₀+ . . . +HᵢPₙsₙ, and a signal after the decoding is yᵢ=Dᵢrᵢ=DᵢHᵢP₀s₀+ . . . +DᵢHᵢPₙsₙ.

diag(DᵢHᵢP₀s₀) which is a diagonal element of the signal after the decoding means reception of original information or original data, and DᵢHᵢP₀s₀−diag(DᵢHᵢP₀s₀) which is generated by removing the diagonal element from the signal after the decoding corresponds to inter-layer interference. Accordingly, the PC-PDC search unit 532 selects a DFT matrix P₀ maximizing the diagonal element of DᵢHᵢP₀ from the DFT codebook.

At this time, a codebook of Table 1 is a DFT codebook in which a resolution for 4 Phase Shift Key (4PSK) is θ, a size of the codebook is 4, and the number of antennas of the transmitter side is 4, and phase values of column elements of the DFT matrixes may constantly increase.

TABLE 1

| PMI | 0 | 1 | 2 | 3 |
|---|---|---|---|---|
| precoder | $[ \begin{matrix}1 \\ {e}^{j θ} \\ {e}^{j 2 θ} \\ {e}^{j 3 θ}\end{matrix} ]$ | $[ \begin{matrix}1 \\ {e}^{j 2 θ} \\ {e}^{j 4 θ} \\ {e}^{j 6 θ}\end{matrix} ]$ | $[ \begin{matrix}1 \\ {e}^{j 3 θ} \\ {e}^{j 6 θ} \\ {e}^{j 9 θ}\end{matrix} ]$ | $[ \begin{matrix}1 \\ {e}^{j 4 θ} \\ {e}^{j 8 θ} \\ {e}^{j 12 θ}\end{matrix} ]$ |

For example, in the DFT codebook, phase values of column elements in a DFT matrix corresponding to PMI=0 may increase by θ and phase values of column elements in DFT matrixes corresponding to PMI=1, 2, and 3 may increase by 2θ, 3θ, and 4θ, respectively.

A codebook of Table 2 is a DFT codebook in which a resolution for 16 Phase Shift Key (16PSK) is θ, a size of the codebook is 16, the number of antennas of the transmitter side is n (n is a natural number equal to or larger than 3), and phase values (0, and θ to 15θ) of column elements of DFT matrixes may constantly increase.

TABLE 2

| | | | | | | | | |
|---|---|---|---|---|---|---|---|---|
| $[ \begin{matrix}1 \\ 1 \\ 1 \\ ⋮\end{matrix} ]$ | $[ \begin{matrix}1 \\ {e}^{j θ} \\ {e}^{j 2 θ} \\ ⋮\end{matrix} ]$ | $[ \begin{matrix}1 \\ {e}^{j 2 θ} \\ {e}^{j 4 θ} \\ ⋮\end{matrix} ]$ | $[ \begin{matrix}1 \\ {e}^{j 3 θ} \\ {e}^{j 6 θ} \\ ⋮\end{matrix} ]$ | $[ \begin{matrix}1 \\ {e}^{j 4 θ} \\ {e}^{j 8 θ} \\ ⋮\end{matrix} ]$ | . . . | $[ \begin{matrix}1 \\ {e}^{j 8 θ} \\ {e}^{j 16 θ} \\ ⋮\end{matrix} ]$ | . . . | $[ \begin{matrix}1 \\ {e}^{j 15 θ} \\ {e}^{j 30 θ} \\ ⋮\end{matrix} ]$ |

Although the PMI is not shown in Table 2, PMI=0 may be indicated for a first DFT matrix and PMI=15 may be indicated for a last DFT matrix. Accordingly, 4 bits are required to express the precoding matrix by using the 16PSK DFT codebook.

As known from Tables 1 and 2, the DFT codebooks correspond to DFT codebooks in which the resolution for 4PSK and 16PSK are θ, sizes of the codebooks are 4 and 16, the number of antennas in the transmitter side is n (n is a natural number equal to or larger than 3), and the phase values of the column elements of the DFT matrixes may constantly increase, but the present invention is not limited thereto. The DFT codebook corresponds to a DFT codebook, which may have any resolution for 4PSK, 8PSK, 16PSK, or 32PSK and any codebook size, and have n (n is a natural number equal to or larger than 3) antennas when the transmitter side has two or more antennas, wherein the phase value either may constantly increase or may not constantly increase. Hereinafter, although a 16PSK DFT codebook will be described as an example, another codebook in a type different from the 16PSK DFT codebook may be equally applied.

The channel state information generator 534 generates a Precoding Matrix Indicator (PMI) corresponding to the index of the aforementioned precoding matrix based on the precoder information and the post-decoder information estimated by the PC-PDC search unit 532. For example, the channel state information generator 534 may generate an index of the DFT matrix P₀ maximizing the diagonal element of DᵢHᵢP₀ selected by the PC-PDC search unit 532 as the PMI from the DFT codebook. For example, in a case where the 16PSK DFT codebook of Table 2 is used, when the precoding matrix corresponds to a third DFT matrix, PMI=2.

The multiple access information generator 536 generates the multiple access information based on the long term/wideband statistic property estimated by the channel estimator 520, and the precoder information and the post-decoder information estimated by the PC-PDC search unit 532.

As described above, the multiple access information generator 536 may generate the BCI of at least one DFT matrix having a sufficiently low similarity with the precoding matrix, within a subset corresponding to DFT matrixes having a relatively large phase difference from the precoding matrix in a set including the precoding matrix corresponding to at least one of the DFT matrixes of the DFT codebook suitable for the estimated channel from the DFT codebook including at least two sets having different similarities of the DFT matrixes.

[1] Specifically, when a transmitted signal is Sₜ=P₀s₀+ . . . +Pₙsₙ, a received signal of a particular user equipment i is rᵢ=HᵢSₜ=HᵢP₀s₀+ . . . +HᵢPₙsₙ and a signal after the decoding is yᵢ=Dᵢrᵢ=DᵢHᵢP₀s₀+ . . . +DᵢHᵢPₙsₙ. At this time, DᵢHᵢPₘsₘ, m≠i means interference between user equipments.
[2] The BCI is an index of a matrix Pₘ minimizing DᵢHᵢPₘsₘ. At this time, when DᵢHᵢ⊥Pₘ, interference is not generated. Since the PMI is an index of the precoding matrix P₀ maximizing the diagonal element of DᵢHᵢP₀, the BCI may be selected as the index of the precoding matrix Pₘ having a low similarity with the precoding matrix P⁰.

Accordingly, matrixes having a high similarity with the precoding matrix P⁰ have a low possibility to be selected as the BCI, so that the BCI is selected after a codebook size is reduced by selecting the PMI and then removing codewords having a high similarity with the selected PMI. As a result, it is possible to reduce the number of bits required for indexing best companion information required when reporting the BCI.

BCI candidates may be selected by calculating the chordal distance which is one of the most general methods of grasping the similarity, and the BCI candidates may be selected based on a correlation between the PMI and other codewords or a size of the correlation.

The multiple access information generator 536 divides the DFT matrixes of the DFT codebook into at least two sets having different correlations. As shown from Table 3, referring to correlations between the DFT matrixes of the 16PSK DFT codebook, there is a high correlation between a first DFT matrix (PMI=0) and a second DFT matrix (PMI=1), but there is no correlation between the first DFT matrix (PMI=0) and a third DFT matrix (PMI=2).

TABLE 3

| PMI | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| 0 | 1 | 0.64 | 0 | 0.22 | 0 | 0.15 | 0 | 0.13 | 0 | 0.13 | 0 | 0.15 | 0 | 0.22 | 0 | 0.64 |
| 1 | 0.64 | 1 | 0.64 | 0 | 0.22 | 0 | 0.15 | 0 | 0.13 | 0 | 0.13 | 0 | 0.15 | 0 | 0.22 | 0 |
| 2 | 0 | 0.64 | 1 | 0.64 | 0 | 0.22 | 0 | 0.15 | 0 | 0.13 | 0 | 0.13 | 0 | 0.15 | 0 | 0.22 |
| 3 | 0.22 | 0 | 0.64 | 1 | 0.64 | 0 | 0.22 | 0 | 0.15 | 0 | 0.13 | 0 | 0.13 | 0 | 0.15 | 0 |
| 4 | 0 | 0.22 | 0 | 0.64 | 1 | 0.64 | 0 | 0.22 | 0 | 0.15 | 0 | 0.13 | 0 | 0.13 | 0 | 0.15 |
| 5 | 0.15 | 0 | 0.22 | 0 | 0.64 | 1 | 0.64 | 0 | 0.22 | 0 | 0.15 | 0 | 0.13 | 0 | 0.13 | 0 |
| 6 | 0 | 0.15 | 0 | 0.22 | 0 | 0.64 | 1 | 0.64 | 0 | 0.22 | 0 | 0.15 | 0 | 0.13 | 0 | 0.13 |
| 7 | 0.13 | 0 | 0.15 | 0 | 0.22 | 0 | 0.64 | 1 | 0.64 | 0 | 0.22 | 0 | 0.15 | 0 | 0.13 | 0 |
| 8 | 0 | 0.13 | 0 | 0.15 | 0 | 0.22 | 0 | 0.64 | 1 | 0.64 | 0 | 0.22 | 0 | 0.15 | 0 | 0.13 |
| 9 | 0.13 | 0 | 0.13 | 0 | 0.15 | 0 | 0.22 | 0 | 0.64 | 1 | 0.64 | 0 | 0.22 | 0 | 0.15 | 0 |
| 10 | 0 | 0.13 | 0 | 0.13 | 0 | 0.15 | 0 | 0.22 | 0 | 0.64 | 1 | 0.64 | 0 | 0.22 | 0 | 0.15 |
| 11 | 0.15 | 0 | 0.13 | 0 | 0.13 | 0 | 0.15 | 0 | 0.22 | 0 | 0.64 | 1 | 0.64 | 0 | 0.22 | 0 |
| 12 | 0 | 0.15 | 0 | 0.13 | 0 | 0.13 | 0 | 0.15 | 0 | 0.22 | 0 | 0.64 | 1 | 0.64 | 0 | 0.22 |
| 13 | 0.22 | 0 | 0.15 | 0 | 0.13 | 0 | 0.13 | 0 | 0.15 | 0 | 0.22 | 0 | 0.64 | 1 | 0.64 | 0 |
| 14 | 0 | 0.22 | 0 | 0.15 | 0 | 0.13 | 0 | 0.13 | 0 | 0.15 | 0 | 0.22 | 0 | 0.64 | 1 | 0.64 |
| 15 | 0.64 | 0 | 0.22 | 0 | 0.15 | 0 | 0.13 | 0 | 0.13 | 0 | 0.15 | 0 | 0.22 | 0 | 0.64 | 1 |

Since the correlations of the DFT matrixes of the DFT codebook are equal between other DFT matrixes, the DFT matrixes of the DFT codebook may be divided into at least two sets having different correlations, such as {0 2 4 6 8 10 12 14}, and {1 3 5 7 9 11 13 15}. There is a high correlation between the DFT matrixes included in different sets, and there is no correlation between the DFT matrixes included in the same set. Accordingly, one of the DFT matrixes included in the set including the PMI may be determined as the BCI. Therefore, it is possible to reduce the number of bits expressing the BCI.

For example, when the precoding matrix corresponds to the third DFT matrix of Table 2, the channel state information generator 534 generates PMI=2 as the channel state information. At this time, the multiple access information generator 536 may generate the BCI from the set including PMI=2, that is, {0 2 4 6 8 10 12 14}.

The multiple access information generator 536 may configure a subset corresponding to the DFT matrixes having a relatively large phase difference from the precoding matrix in a set including the precoding matrix and generate the BCI of at least one DFT matrix having a sufficiently low similarity with the precoding matrix within the subset.

Specifically, since the DFT matrixes having a small phase difference from the precoding matrix corresponding to the PMI among the DFT matrixes have a relatively large precoding gain due to angular spread of a transmitted wave of the transmitter side which spreads with a predetermined angle, the DFT matrixes have low possibilities to be the optimal selection companions in the MU-MIMO.

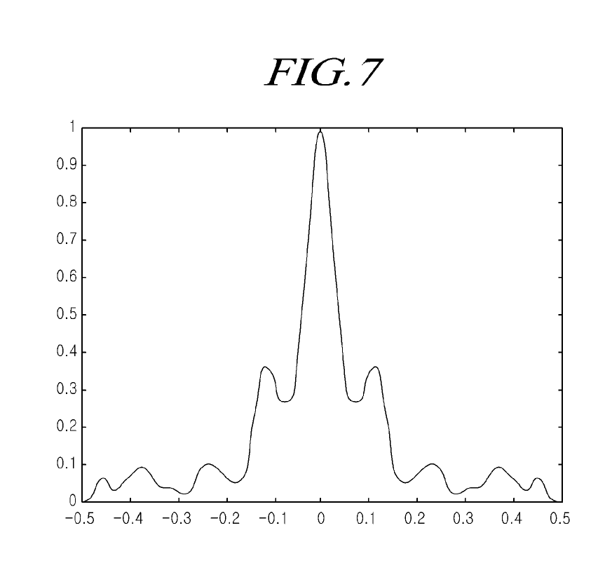

FIG. 7 illustrates a pattern of a precoding gain of PMI=0 according to a resolution of the DFT precoding matrix and a propagation angle of the transmitter side. As shown in FIG. 7, in the pattern of the precoding gain, a sharpness of the pattern increases as the number of antennas of the transmitter side increases, and accordingly a resolution of beam division of a beam which is a flow of the transmitted wave or an electromagnetic wave also increases. At this time, when the number of beams included in the codebook of the precoding matrix is larger than the number of beams divisible through the resolution, there is a correlation between precoding matrixes having a small phase difference among the DFT matrixes in the beam formation.

Accordingly, a subset is configured by only DFT matrixes having a relatively large phase difference except for DFT matrixes having a small phase difference from the preceding matrix from a set including the precoding matrix among at least two sets having different similarities of the DFT matrixes in the DFT codebook, and one of the DFT matrixes included in the subset is generated as the BCI.

For example, when PMI=2, the set including PMI=2 is {0 2 4 6 8 10 12 14}, and the subset may be configured by the remaining indexes {8, 10, 12} except for indexes corresponding to the DFT matrixes having the small phase difference from the DFT matrix corresponding to PMI=2 in the set, that is, 0, 4, 6, and 14. Through a general expansion for the subset, the following Equation may be derived.

Companion subset for PMI=n:{(n+6)mod 16(n+8)mod 16(n+10)mod 16} [Equation 3]

The multiple access information generator 536 sequentially assigns reindexes to the DFT matrixes included in the subset and then may generate the BCI of at least one DFT matrix having a sufficiently low similarity with the precoding matrix within the subset.

For example, when PMI=2, reindexes {0, 1, 2} are sequentially assigned to the DFT matrixes {8, 10, 12} included in the subset, and then BCI=1 may be generated when a PMI corresponding to the DFT matrix having a lowest similarity with the precoding matrix is 10.

At this time, the DFT matrixes of the DFT codebook may generate the multiple access information, for example, the BCI in the same way even when DFT matrixes of a different resolution from 16PSK DFT matrixes, such as 4PSK, 16PSK, 32PSK or the like is used as well as using the 16PSK DFT matrixes.

In transmission of rank 2 or more of simultaneously transmitting at least two codewords through at least two layers, the multiple access information, for example, the BCI may be generated in the same way. For example, a channel is estimated for each of at least two layers, and an index of the DFT matrix having a low similarity with the precoding matrix may be generated as the BCI of the subset among a common DFT matrix between DFT matrixes having a relatively large phase difference from each of the precoding matrixes and DFT matrixes adjacent to the common DFT matrix in a set including at least the precoding matrixes suitable for the estimated channels.

For example, a user equipment i selects three precoding matrixes {4 6 8} as the subset in each of the subsets {6 8 10} and {2 4 6} in rank 2 transmission using two beams corresponding to PMI=0 and PMI=12, and an index of the matrix having a low similarity with the precoding matrixes corresponding to PMI=0 and PMI=12 may be generated as the BCI.

Referring back to FIG. 5, the feedback unit 540 may transmit feedback of the channel information generated by the channel information generator 530 to the base station 420.

Through the above described embodiment, it is possible to reduce feedback overheads of the companion selection information (companion indicator) of the user equipment in multiple accesses by the MU-MIMO.

In the above description, the channel state information feedback apparatus according to an embodiment in the MIMO system has been discussed, and hereinafter, a channel state information feedback method according to an embodiment in the MIMO system will be discussed.

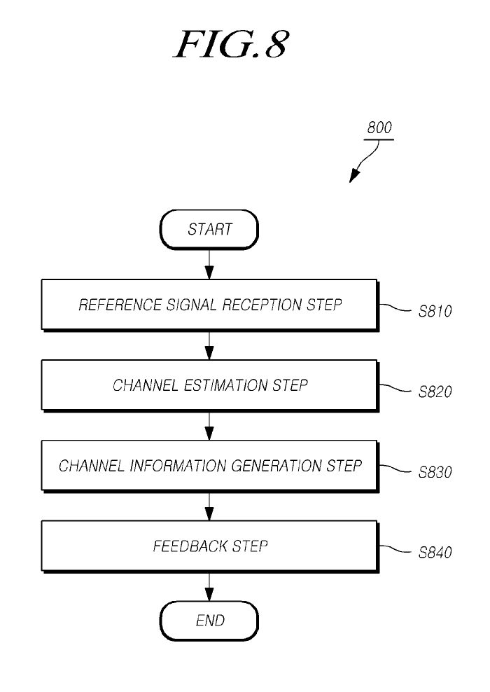

FIG. 8 is a flowchart of the channel state information feedback method according to another embodiment in the MIMO system.

The MU-MIMO channel state information feedback method 800 according to another embodiment includes a reference signal reception step (S810) of receiving a reference signal, for example, a Channel State Index-Reference Signal (CSI-RS), a Common Reference Signal (CRS), or a Demodulation-Reference Signal (DM-RS) from the base station, a channel estimation step (S820) of estimating a channel by using the received reference signal, a channel information generation step (S830) of generating corresponding channel information based on a channel estimation result, and a feedback step (S840) of feeding back the channel information.

The reference signal reception step (S810) and the channel estimation step (S820) may be separately or integratively implemented in the above description, or may be integratively implemented in some cases.

Since a cell specific CSI-RS is received and there is information on the band (subcarrier) of the received signal and the symbol by which the CSI-RS is received in the reference signal reception step (S810), a reception value of the CSI-RS may be measured by determining a signal of the time-frequency domain.

A function of estimating the channel by using the received CSI-RS is performed in the channel estimation step (S820), and the channel estimation is performed as follows. The reception value of the CSI-RS received in the reference signal reception step (S810) is as defined in Equation 1. Since r̅^{RS} corresponding to the reception value of the received CSI-RS may be known by the measurement and t̅^{RS} corresponding to a transmission value of the CSI-RS is a value already known between the user equipment and the base station, H corresponding to a propagation channel may be estimated using a general channel estimation scheme.

Further, in the channel estimation step (S820), a long term/wideband statistic property of the propagation channel H corresponding to the channel estimation result may be estimated at regular intervals. For example, the long term/wideband statistic property may be an average value of the channel matrix for a predetermined time or a channel correlation matrix R expressed by Equation 2 above.

Subsequently, in the channel information generation step (S830), channel state information may be generated based on the propagation channel H corresponding to the channel estimation result of the channel estimation step (S820) or the long term/wideband statistic property, for example, the channel correlation matrix R. As described above, the channel information contains channel state information on the user equipment corresponding to the index (PMI) of the precoding matrix of the user equipment suitable for the propagation channel H or the long term/wideband statistic property estimated for a particular frequency band, for example, the channel correlation matrix R and multiple access information on another user equipment according to multiple accesses determined by the user equipment corresponding to the BCI of at least one DFT matrix having a sufficiently low similarity with the precoding matrix within the subset corresponding to DFT matrixes having a relatively large phase difference from the precoding matrix in the set including the precoding matrix which is one of DFT matrixes of the DFT codebook suitable for the channel estimated from the codebook including at least two sets having different similarities of the DFT matrixes.

In the above description, some steps of the channel information feedback apparatus according to an embodiment in the MIMO system have been discussed, and hereinafter, examples of a channel information generation step corresponding to one of steps of the channel information feedback method according to an embodiment in the MIMO system will be discussed.

FIG. 9 is a flowchart illustrating an example of a channel state information generation method according to another embodiment.

The channel information generation method 900 illustrated in FIG. 9 corresponds to a part of the aforementioned channel state information generation step (S830) and also may configure an independent method. In other words, the channel information generation method 900 illustrated in FIG. 9 may configure the method independent from steps before and after the channel information generation step (S830) of FIG. 8. Accordingly, the channel information generation method 900 may be included to implement another technology.

Referring to FIGS. 8 and 9, the estimated propagation channel and long term/wideband statistic property corresponding to the channel estimation result of the channel estimation step (S820) are input in step S920. The propagation channel and the long term/wideband statistic property may be the same as those described with reference to Equations 1 and 2 as describe above.

Next, an optimal precoder and post-decoder are searched based on the input propagation channel and long term/wideband statistic property, and an optimal precoding scheme or precoder (PC) and an optimal post-decoding scheme or post-decoder (PDC) may be determined using various precoding techniques in step S920.

Specifically, in step S920, optimal precoder information is searched for from the DFT codebook shown in Table 1 or 2 consisting of the DFT matrixes including only indexes and a phase corresponding to each of the indexes based on the propagation channel and the long term/wideband statistic property estimated in the channel estimation step (S820), and the post-decoder may be estimated based on the found precoder information. As described above, the DFT codebook corresponds to a DFT codebook, which may have any resolution for 4PSK, 8PSK, 16PSK, or 32PSK and any codebook size, and have n (n is a natural number equal to or larger than 3) antennas when the transmitter side has two or more antennas, wherein the phase value either may constantly increase or may not constantly increase.

Next, the channel state information including the Precoding Matrix Indicator (PMI) corresponding to the index for the precoding matrix is generated based on the precoder information and the post-decoder estimated in step S920 in step S950. Specifically, as described above, when the precoding matrix is determined by searching the DFT codebook for the precoding matrix estimated in step S920, the PMI for the precoding matrix is generated in step S950.

Next, the multiple access information is generated based on the propagation channel and the long term/wideband statistic property estimated in the channel estimation step (S820) and the precoder information and the post-decoder estimated in step S920 in step S960.

For example, in step S960, as described above, the BCI for at least one DFT matrix having a sufficiently low similarity with the precoding matrix may be generated within a subset corresponding to DFT matrixes having a relatively large phase difference from the precoding matrix in a set including the precoding matrix corresponding to at least one of the DFT matrixes of the DFT codebook suitable for the estimated channel from the DFT codebook including at least two sets having different similarities of the DFT matrixes.

Specifically, in step S960, the DFT matrixes of the DFT codebook are divided into at least two sets having different correlations. That is, since the correlations of the DFT matrixes of the DFT codebook are equal between other DFT matrixes, the DFT matrixes of the DFT codebook may be divided into at least two sets having different correlations, such as {0, 2, 4, 6, 10, 12, 14} and {1, 3, 5, 7, 9, 11, 13, 15}.

Thereafter, a subset is configured by only DFT matrixes having a relatively large phase difference except for DFT matrixes having a small phase difference from the preceding matrix from a set including the precoding matrix among at least two sets having different similarities of the DFT matrixes in the DFT codebook, and one of the DFT matrixes included in the subset is generated as the BCI.

As described above, when PMI=2, the set including PMI=2 is {0, 2, 4, 6, 10, 12, 14}, and the subset may be configured by the remaining {8, 10, 12} except for indexes corresponding to the DFT matrixes having the small phase difference from the DFT matrix corresponding to PMI=2 in the set, that is, 0, 4, 6, and 14.

Lastly, reindexes are sequentially assigned to the DFT matrixes included in the subset, and then the BCI for at least one DFT matrix having the sufficiently low similarity with the precoding matrix may be generated within the subset. For example, reindexes {0, 1, 2} are sequentially assigned to the DFT matrixes included in the subset {8, 10, 12}. Finally, the BCI for at least one DFT matrix having the sufficiently low similarity with the precoding matrix within the subset, for example, BCI=1 may be generated. As a result, BCI=1 corresponds to the DFT matrixes identical to PMI=10 in the codebook of Table 2.

Meanwhile, in step S960, in transmission of rank 2 or more of simultaneously transmitting at least two codewords through at least two layers, the multiple access information, for example, the BCI may be generated in the same way. For example, a channel is estimated for each of at least two layers, and an index for the DFT matrix having a low similarity with the precoding matrix may be generated as the BCI of the subset among a common DFT matrix between DFT matrixes having a relatively large phase difference with each of the precoding matrixes and DFT matrixes adjacent to the common DFT matrix in a set including at least the precoding matrixes suitable for the estimated channels.

Referring back to FIG. 8, the feedback step (S840) transmits the feedback of the channel information containing the channel state information and the multiple access state information to the base station.

In the above description, the channel state information feedback method according to an embodiment in the MIMO has been discussed, and hereinafter, the base station according to another embodiment will be discussed.

FIG. 10 is a block diagram of the base station according to another embodiment.

A base station or a base station apparatus 1000 includes a layer mapper 1020 for mapping a codeword 1010 into a layer, a precoder 1030 for precoding data symbols, and an antenna array 1040 including two or more antennas propagating a precoded symbol into the air. Since configurations of the layer mapper 1020, the precoder 1030, and the antenna array 1040 are the same as current or future general configurations or substantially similar, detailed descriptions thereof will be omitted.

The base station 1000 may precode data symbols by using two precoders, that is, precoders 1030. At this time, each of the precoders may precode data symbols by its own precoding matrix.

Each user equipment transmits the channel information containing the channel state information and the multiple access information to the base station 1000 through the above described method.

At this time, the channel state information may be the PMI for the precoding matrix determined by searching the DFT codebook. The multiple access information may be the BCI which is one of the DFT matrixes included in the subset when the subset is configured by only the DFT matrixes having the relatively large phase different except for the DFT matrixes having the small phase difference from the precoding matrix in the set including the precoding matrix among at least two sets having different similarities of the DFT matrixes in the DFT codebook.

Further, the base station 1000 includes a user terminal selector 1060 and a precoder generator 1070. At this time, the user equipment selector 1060 and the precoder generator 1070 may be a part of the scheduler 426 illustrated in FIG. 4 or a separate component from the scheduler 426. Accordingly, descriptions related to the user equipment selector 1060 and the precoder generator 1070 may correspond to the description related to the scheduler 426 illustrated in FIG. 4.

The user equipment selector 1060 determines SU-MIMO transmission or MU-MIMO transmission based on the channel information containing the channel states, the channel state information, and the multiple access information reported from each user equipment and selects the user equipments. When the SU-MIMO transmission is determined, the user equipment selector 1060 selects one user equipment.

Meanwhile, when the MU-MIMO is determined, the user equipment selector 1060 compares the channel information containing the CQIs, the channel state information, and the multiple access information reported from each user equipment and grasps correlation between the user equipments. The user equipment selector 1060 selects user equipments satisfying a particular condition based on the correlation between the user equipments. At this time, the user equipments satisfying the particular condition may refer to user equipments having smallest channel interference between the user equipments, but the present invention is not limited thereto.

At this time, when a precoding matrix designated by the PMI of each user equipment corresponds to one of precoding matrixes designated by BCIs of other user equipments, the user equipment selector 1060 may determine the MU-MIMO transmission of the user equipment and one or more other user equipments. For example, when a PMIn reported from a user equipment n corresponds to a BCIm reported from a user equipment m and a BCIn reported from the user equipment n corresponds to a PMIm reported from the user equipment m, the base station allows simultaneous accesses by the user equipment n and the user equipment m with the MU-MIMO mode.

At this time, the user equipment selector 1060 may configure a subset by only DFT matrixes having a relatively large phase difference except for DFT matrixes having a small phase difference from the precoding matrix in a set including the PMI reported as the channel state information, identify a subset including the BCI reported as the multiple access information, sequentially assign reindexes to the DFT matrixes included in the subset, and determine DFT matrixes corresponding to the reindexes of the subset from the BCI reported as the multiple access information.

For example, when the reported PMI=2 and BCI=1, the subset {8, 10, 12} may be configured by the DFT matrix having the large phase difference from the precoding matrix corresponding to PMI=2 in the set {0, 2, 4, 6, 10, 12, 14} included in the PMI=2, and a second DFT matrix of the subset corresponding to BCI=1 may be determined as the multiple access information. Accordingly, it may be known that PMI=2 and BCI=1 reported by the user equipment n are PMI=2 and BCI=10 when being converted to the PMI of Table 2. It may be identified whether BCIn=PMIm by converting the PMI and BCI reported by the user equipment in the same way, and thus it may be determined whether the simultaneous accesses are possible.

The precoder generator 1070 generates precoding matrixes of one user equipment or two or more user equipments selected by the user equipment selector 1060. At this time, the precoder generator 1070 generates the precoding matrixes of the one user equipment or the two or more user equipments based on the channel information reported from the user equipments selected by the user equipment selector 1060, for example, PMIs and BCIs of the selected user equipments.

In the above description, the base station according to another embodiment has been discussed, and hereinafter, a transmission method of the base station according to another embodiment will be discussed.

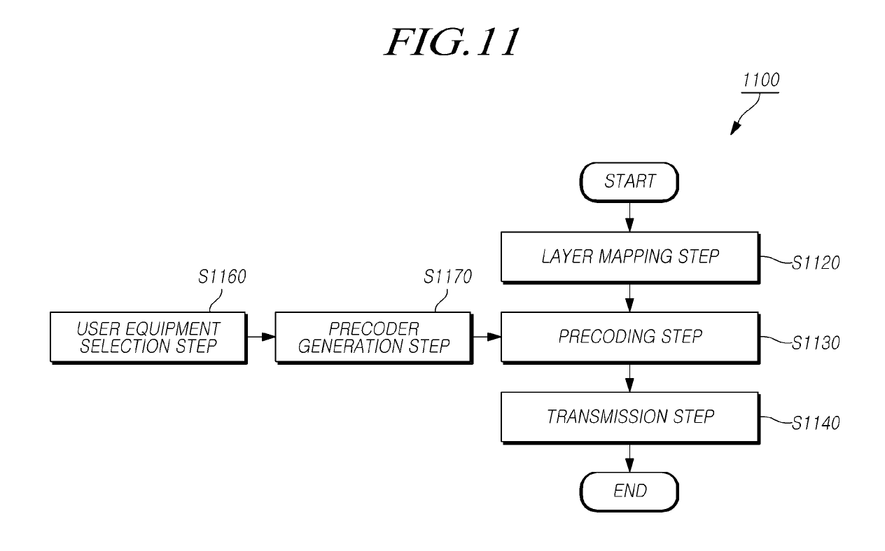

FIG. 11 is a flowchart of the transmission method of the base station according to another embodiment.

Referring to FIG. 11, the transmission method 1100 of the base station according to another embodiment includes a layer mapping step (S1120) of mapping a codeword into a layer, a precoding step (S1130) of precoding symbols, and a transmission step (S1140) of propagating a precoded symbol into the air through two or more antennas. Since configurations of the layer mapping step (S1120), the precoding step (S1130), and the transmission step (S1140) are the same as current or future general configuration or substantially similar, a detailed description thereof will be omitted.

However, data symbols may be precoded by one precoding matrix by using each of two precoders in step S1140.

Further, the transmission method 1100 of the base station according to another embodiment includes a user equipment selection step (S1160) and a precoder generation step (S1170).

The user equipment selection step (S1160) determines SU-MIMO transmission or MU-MIMO transmission based on the channel information containing the CQIS, the channel state information, and the multiple access information reported from each user equipment and selects the user equipments. The user equipment selection step (S1160) selects one user equipment when the SU-MIMO transmission is determined. Meanwhile, the user equipment selection step (S1160) compares the channel information containing the CQIs, the channel state information, and the multiple access information reported from each user equipment and grasps correlation between the user equipments when the MU-MIMO transmission is determined.

Specifically, as described above, the user equipment selection step (S1160) may determine precoding matrixes designated by BCIs of other user equipments based on a particular codebook as in relation to the user equipment selector 1060.

The precoder generation step (S1170) generates a precoding matrix of user equipment(S) selected in the user equipment selection step (S1160). At this time, the precoder generation step (S1170) generates the precoding matrix of the user equipment(s) based on the channel information reported from the user equipments selected in the user equipment selection step (S1160).

In the above description, although the embodiments have been discussed with reference to the accompanying drawings, the present invention is not limited thereto.

The above described embodiments may be applied to the uplink/downlink MIMO system, and may be applied to all kinds of uplink/downlink MIMO systems including a single cell environment, a Coordinated Multi-Point transmission/reception system (CoMP), a heterogeneous network and the like.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A transmission method of channel information by an apparatus in a
wireless communication system, the method comprising:
estimating a channel by receiving a reference signal;
estimating a precoding matrix suitable for the estimated channel from a Discrete Fourier Transform (DFT) codebook including two or more sets having different similarities of DFT matrixes, configuring a subset by DFT matrixes having a relatively large phase difference from the precoding matrix in a set including the precoding matrix, and generating channel information containing multiple access information on one or more DFT matrixes having a sufficiently low similarity with the precoding matrix within the subset; and
transmitting the channel information generated in generating the channel information into an air.

2. The transmission method as claimed in claim 1, wherein the multiple access information is an index (best companion indicator) corresponding to the one or more DFT matrixes having the sufficiently low similarity with the precoding matrix.

3. The transmission method as claimed in claim 1, wherein, when a number of bits expressing indexes corresponding to DFT matrixes included in each set is n, a number of bits expressing indexes corresponding to DFT matrixes included in the subset is smaller than n.

4. The transmission method as claimed in claim 1, wherein, in transmission of rank 2 or more of simultaneously transmitting two or more codewords through two or more layers, channels are estimated for each of the two or more layers in estimating the channel, and in generating the channel information, the subset is a common DFT matrix between DFT matrixes having a relatively large phase difference from each of two or more precoding matrixes and DFT matrixes adjacent to the common DFT matrix, in a set including the two or more precoding matrixes suitable for the channels estimated in estimating the channel.

5. The transmission method as claimed in claim 1, wherein the apparatus is a base station or a user equipment.

6. The transmission method as claimed in claim 1, wherein the DFT matrixes of the DFT codebook have a resolution of one of 4 Phase Shift Key (PSK), 8PSK, 16PSK, and 32PSK.

7. The transmission method as claimed in claim 1, wherein phase values of column elements of the DFT matrixes of the DFT codebook constantly increase.

8. The transmission method as claimed in claim 1, wherein the similarity is orthogonality or correlation.

9. The transmission method as claimed in claim 1, wherein the channel information contains channel state information on the precoding matrix corresponding to one of the DFT matrixes of the DFT codebook suitable for the estimated channel.

10. A channel information feedback apparatus in a wireless communication system, comprising:
a channel estimator for estimating a channel receiving by a reference signal;
a channel information generator for estimating a precoding matrix suitable for the channel estimated by the channel estimator from a Discrete Fourier Transform (DFT) codebook including two or more sets having different similarities of DFT matrixes, configuring a subset by DFT matrixes having a relatively large phase difference from the precoding matrix in a set including the precoding matrix, and generating channel information containing multiple access information on one or more DFT matrixes having a sufficiently low similarity with the precoding matrix within the subset; and
a feedback unit for feeding back the generated channel information.

11. The apparatus as claimed in claim 10, wherein the multiple access information is an index (best companion indicator) corresponding to one or more DFT matrixes having a sufficiently low similarity with the precoding matrix.

12. The apparatus as claimed in claim 10, wherein, when a number of bits expressing indexes corresponding to DFT matrixes included in each set is n, a number of bits expressing indexes corresponding to DFT matrixes included in the subset is smaller than n.

13. The apparatus as claimed in claim 10, wherein, in transmission of rank 2 or more of simultaneously transmitting two or more codewords through two or more layers, the channel estimator estimates channels for each of the two or more layers in estimating the channel, and the subset is a common DFT matrix between DFT matrixes having relatively large phase difference from each of two or more precoding matrixes and DFT matrixes adjacent to the common DFT matrix, in a set including the two or more precoding matrixes suitable for the channels estimated in estimating the channel in generating the channel information.

14. The apparatus as claimed in claim 10, wherein the DFT matrixes of the DFT codebook have a resolution of one of 4 Phase Shift Key (PSK), 8PSK, 16PSK, and 32PSK.

15. The apparatus as claimed in claim 10, wherein phase values of column elements of the DFT matrixes of the DFT codebook constantly increase.

16. The apparatus as claimed in claim 10, wherein the similarity is orthogonality or correlation.

17. The apparatus as claimed in claim 10, wherein the channel information contains channel state information for the precoding matrix corresponding to one of the DFT matrixes of the DFT codebook suitable for the estimated channel.

18. A base station comprising:
a layer mapper for mapping a data symbol into a layer;
a precoder for receiving feedback of channel state information and multiple access information from one or more user equipments and precoding mapped symbols by using each precoding matrix;
a scheduler for, when the user equipment allows simultaneous accesses of the user equipment and one or more other user equipments, selecting a user equipment to receive data by using the channel state information and the multiple access information and generating precoding matrixes of the precoder; and
an antenna array including two or more antennas for propagating a precoded symbol into an air,
wherein, when a precoding matrix suitable for a channel estimated by receiving a reference signal by a user equipment is estimated in a Discrete Fourier Transform (DFT) codebook including two or more sets having different similarities of DFT matrixes and a subset is configured by DFT matrixes having a relatively large phase difference from the precoding matrix in a set including the precoding matrix, the multiple access information is information on one or more DFT matrixes having a sufficiently low similarity with the precoding matrix within the subset.

19. A transmission method of a base station, comprising:
mapping a data symbol into a layer;
receiving feedback of channel state information and multiple access information from one or more user equipments and precoding mapped symbols by using each precoding matrix;
when the user equipment allows simultaneous accesses of the user equipment and one or more other user equipments, selecting a user equipment to receive data by using the channel state information and the multiple access information and generating precoding matrixes of a precoder; and
propagating a precoded symbol into an air through an antenna array including two or more antennas,
wherein, when a precoding matrix suitable for a channel estimated by receiving a reference signal by a user equipment is estimated in a Discrete Fourier Transform (DFT) codebook including two or more sets having different similarities of DFT matrixes and a subset is configured by DFT matrixes having a relatively large phase difference from the precoding matrix in a set including the precoding matrix, the multiple access information is information on one or more DFT matrixes having a sufficiently low similarity with the precoding matrix within the subset.
